(19) United States
(12) Patent Application Publication
(10) Pub. No.: US 2012/0316886 A1
(43) Pub. Date: Dec. 13, 2012

(54) SPARSE CODING USING OBJECT EXTTRACTION

(76) Inventors: Ramin Pishehvar, Ottawa (CA); Hossein Najaf-Zadeh, Stittsville (CA); Frederic Mustiere, Ottawa (CA); Christopher Srinivasa, Ottawa (CA); Hassan Lahdili, Gatineau (CA); Louis Thibault, Gatineau (CA)

(21) Appl. No.: 13/491,776

(22) Filed: Jun. 8, 2012

Related U.S. Application Data
(60) Provisional application No. 61/494,460, filed on Jun. 8, 2011.

(51) Int. Cl. G10L 19/00

(52) U.S. Cl. 704/500; 704/E19.001

(57) ABSTRACT

The invention relates to a method and apparatus for efficient encoding of media signals including audio. A 2d sparse representation, or spikegram, of one frame of a digitized audio signal is generated using an overcomplete set of kernels. The spikegram is then mapped to a non-negative matrix, which is decomposed into a 3D component matrix containing hidden components and a 3D weight matrix using a two-dimensional non-negative matrix factorization. Elements of the 3D component and weight matrices are then adaptively quantized using integer programming to determine an optimal quantization scheme, and the quantized values are the optionally encoded using an arithmetic coder.

### CROSS-REFERENCE TO RELATED APPLICATIONS

The present invention claims priority from U.S. Provisional Patent Application No. 61/494,460 filed Jun. 8, 2011, which is incorporated herein by reference.

### TECHNICAL FIELD

The present invention generally relates to methods and apparatuses for signal processing, and more particularly relates to encoding of audio signals and other types of media signals.

### BACKGROUND OF THE INVENTION

Many types of signals can be well-approximated by a small subset of elements from an over complete dictionary. The process of choosing a good subset of dictionary elements from an overcomplete dictionary set, along with their weights, to represent a signal is known as sparse approximation, sparse representation, or sparse coding.

In the over-complete shift-invariant representations, the number of dictionary elements in the dictionary set, which are also referred to as basis vectors or kernels, is greater than the real dimensionality—number of non-zero eigenvalues in the covariance matrix—of the input signal. This technique matches the best kernels to different acoustic cues using different convergence criteria such as residual energy. However, the minimization of the energy of the residual, or error, signal is not sufficient to get an over-complete representation of the input signal. Other constraints such as sparseness are considered in order to obtain a unique solution. In order to find the “best matching kernels”, typically a matching pursuit (MP) technique is employed. Description of the MP technique is provided, for example, in Gribonval “Fast matching pursuit with a multiscale dictionary of Gaussian chirps” (IEEE Trans. Signal Processing, 49(5):994-1001, 2001), and in U.S. Patent Application 2008/0219466. Advantageously, over-complete representations are more robust in the presence of noise than conventional coding techniques that represent signal in an orthogonal basis, such as Discrete Cosine Transform (DCT), Modified Discrete Cosine Transform (MDCT) and Discrete Fourier Transform (DFT).

A sparse representation of audio signals is disclosed in an article by R. Pichevar et al., entitled “Auditory-Inspired Sparse Representation of Multimedia Signals with Applications to Audio Coding”, Speech Communication, 2010, which is referred to hereinafter as Ref [1], in U.S. Patent Applications 2008/0219466, and 2012/0023051, all three of which are incorporated herein by reference. These publications describe a biologically-inspired approach, in which an audio signal is projected onto a set of gammatone/gammachirp kernels that generates a sparse two-dimensional time-frequency representation dubbed as a spikegram. A masking model is applied to the spikegrams to remove inaudible spikes and to increase the coding efficiency. U.S. Patent Application 2008/0219466 application, a method to obtain the spikegram using the MP technique is disclosed. U.S. Patent Application 2012/0023051 teaches generating spikegrams using neural networks.

However, addressing each spike in a spikegram individually in the previously proposed approaches may be costly in terms of bits when audio coding applications are considered. It is therefore desirable to provide a method and system that provides a more compact representation of audio signals.

### SUMMARY OF THE INVENTION

Accordingly, the present invention relates to efficient encoding of media signals using sparse encoding of the media signal to generate a two-dimensional spikegram, applying a two-dimensional matrix factor deconvolution to the spikegram to obtain three-dimensional weight and component matrices, and/or adaptive quantization using integer programming to determine an optimal quantization scheme. Media signals as defined herein include audio signals, video signals, and signals representing images.

One aspect of the present invention relates to a method for encoding an audio signal by an audio encoding apparatus comprising data processing hardware, the method comprising: a) receiving a sequence of electrical signal samples representing a selected duration of the audio signal; b) from the received sequence of electrical signal samples, obtaining a two-dimensional spikegram sparsely representing the selected duration of the audio signal in time and frequency domains in terms of an overcomplete signal library; c) generating a set of weight matrices W and a set of component matrices H by performing a two-dimensional non-negative matrix factorization (NMF2D) of the spikegram, or of a non-negative matrix V obtained therefrom, under a sparsity constrain; d) quantizing non-zero values of the weight matrices W and the component matrices H; e) encoding W and H to obtain encoded audio data; and, f) outputting the encoded audio data for transmission to a complimentary audio decoder or storing in a computer-readable medium.

Another aspect of the present invention relates to an audio signal processing apparatus, which comprises a spikegram generation logic for receiving a sequence of electrical signal samples representing a selected duration of an audio signal, and for generating a spikegram based thereon, wherein the spikegram represents the selected duration of the input audio signal in time and frequency domains in terms of an overcomplete signal library, and a matrix factorization logic for generating a set of weight matrices W and a set of component matrices H by performing the two-dimensional non-negative matrix factorization (NMF2D) of the spikegram, or of a non-negative matrix V obtained therefrom, under a sparsity constrain. The audio signal processing apparatus further comprises a quantizer for quantizing non-zero values of the weight matrices W and the component matrices H, and an encoder for encoding the weight matrices W and the component matrices H to obtain encoded audio data for transmission to a complimentary audio decoder or storing in a computer-readable medium.

Another feature of the present invention provides an article of manufacture comprising at least one of: a hardware device having hardware logic for performing operations for encoding an audio signal, and a computer readable storage medium including a computer program code embodied therein that is executable by a computer, said computer program code comprising instructions for performing the operations for encoding the audio signal, said computer program code further comprising distinct software modules, the distinct software modules comprising a spikegram generating module for generating a spikegram and a matrix factorization module for performing a two-dimensional matrix non-negative matrix factorization (NMF2D) of the spikegram. The operations comprise: a) receiving a sequence of electrical signal samples representing a selected duration of the audio signal; b) from the received sequence of electrical signal samples, obtaining a two-dimensional spikegram sparsely representing the selected duration of the audio signal in time and frequency domains in terms of an overcomplete signal library; c) generating a set of weight matrices W and a set of component matrices H by performing NMF2D of the spikegram, or of a non-negative matrix V obtained therefrom, under a sparsity constrain; d) quantizing non-zero values of the weight matrices W and the component matrices H; e) encoding W and H to obtain encoded audio data; and, f) outputting the encoded audio data for transmission to a complimentary audio decoder or storing in a computer-readable medium.

### BRIEF DESCRIPTION OF THE DRAWINGS

The invention will be described in greater detail with reference to the accompanying drawings which represent preferred embodiments thereof, in which like elements are indicated with like reference numerals, and wherein:

FIG. 1 is a chart illustrating steps of a method of signal processing using two-dimensional (2D) non-negative matrix deconvolution (NMD2D) of a sparse 2D signal representation;

FIG. 2 is a chart illustrating steps of a method of audio signal encoding using the method of FIG. 1;

FIG. 3 is a plot illustrating a 25-channel spikegram of an audio signal of 1 sec. duration;

FIG. 4 is a plot illustrating a modified non-negative spikegram obtained from the spikegram of FIG. 4;

FIG. 5 is a chart illustrating one method of generating component and weight matrices using the NMD2D;

FIG. 6 is a chart illustrating a frequency-segmented NMF2D process;

FIG. 7 is a schematic block diagram of an audio signal encoder implementing the method of FIG. 2;

FIG. 8 is a schematic block diagram of an audio signal decoder for use with the audio signal encoder of FIG. 7;

FIG. 9 is a chart illustrating a method of quantizing the weight and component matrices generated by the NMD2D;

FIG. 10 is a schematic graph illustrating the piecewise linear quantization function enabling an optimal non-uniform distribution of quantization levels.

### DETAILED DESCRIPTION

In the following description of the exemplary embodiments of the present invention, reference is made to the accompanying drawings which form a part thereof, and which show by way of illustration specific embodiments in which the invention may be practiced. It is understood that other embodiments may be utilized and structural changes may be made within the scope of the present invention. Reference herein to any embodiment means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments.

In the context of this specification, the term “computing” is used generally to mean generating an output based on one or more inputs using digital hardware, analog hardware, or a combination thereof, and is not limited to operations performed by a digital computer. Similarly, the term ‘processor’ when used with reference to hardware, may encompass digital and analog hardware or a combination thereof. The term processor may also refer to a functional unit or module implemented in software or firmware using a shared hardware processor. The terms ‘output’ and ‘input’ encompass analog and digital electromagnetic signals that may represent data sequences and single values. The terms ‘data’ and ‘signal’ are used herein interchangeably. The terms ‘coupled’ and ‘connected’ are used interchangeably; these terms and their derivatives encompass direct connections and indirect connections using intervening elements, unless clearly stated otherwise. Note that as used herein, the terms “first”, “second” and so forth are not intended to imply sequential ordering, but rather are intended to distinguish one element from another unless explicitly stated.

In the following description, reference is made to the accompanying drawings which form a part thereof and which illustrate several embodiments of the present invention. It is understood that other embodiments may be utilized and structural and operational changes may be made without departing from the scope of the present invention. The drawings include flowcharts and block diagrams. The functions of the various elements shown in the drawings may be provided through the use of data processing hardware such as but not limited to dedicated logical circuits within a data processing device, as well as data processing hardware capable of executing software in association with appropriate software. When provided by a processor, the functions may be provided by a single dedicated processor, by a single shared processor, or by a plurality of individual processors, some of which may be shared. The term “processor” should not be construed to refer exclusively to hardware capable of executing software, and may implicitly include without limitation, logical hardware circuits dedicated for performing specified functions, digital signal processor (“DSP”) hardware, application specific integrated circuits (ASICs), field-programmable gate arrays (FPGAs), read-only memory (“ROM”) for storing software, random access memory (“RAM”), and non-volatile storage. The term ‘memory’ as used herein refers to computer-readable non-transient data storage and encompasses optical disks, magnetic memory devices such as hard drives, solid-state memory, and other types of hardware memory devices.

Embodiments of the present invention use two-dimensional non-negative matrix factorization (NMF2D) to obtain a more compact representation of a spikegram in terms of a collection of its constituent ‘parts’, or ‘components’, and their associated weights. The term ‘more compact’ is used herein to mean a representation that requires less bits than the original, while maintaining perceptual quality of the signal after decoding at an acceptable level.

Part-based representations are used in signal processing and artificial intelligence, since they enable extracting constituent objects of a scene by extracting localized features. One way of achieving part-based analysis is the use of non-negative kernels in a linear model. In this scheme, since each signal is generated by adding up positive, or more generally non-negative kernels, no part of the kernels can be cancelled out by addition. Therefore the kernels, or basis vectors representing them, must be parts of the underlying data. In addition, combining sparseness and non-negativity gives a suitable representation for signals, as has been shown for example in P. Hoyer, Non-negative Matrix Factorization with sparseness constraints, Journal of Machine Learning Research 5: 1457-1469, 2004, and R. Pichevar and J. Rouat, An Improved Sparse Non-Negative Part-Based Image Coder via Simulated Annealing and Matrix Pseudo-Inverse, ICASSP 2008.

Mathematically, a conventional non-negative matrix decomposition is a technique that optimally solves a matrix equation

V≈W·H, (1)

Where V, W and H are matrices having only non-negative elements, where H contains as its rows K basis vectors, or components, of the decomposition, where K is an integer that is greater than 1. The K columns of the weight, or mixing, matrix W contain the corresponding weights that give the contribution of each basis vector in the input matrix V; each element w_{i,j} of W is a projection of the input signal onto the j^{th} vector of H⁻¹. The goal of the NMF is to find both W and H that approximate V by minimizing a cost function E. A variety of cost functions can be used. By way of example, the cost function E may be defined by the following equation (2):

E=∥V−WH∥₂+λ∥H∥, (2)

where the notation ∥X∥ represents a norm of matrix X, wherein the subscript “2” refers to norm L2. The first term in equation (2) represents the error of the approximation of equation (1), and the second term represents a sparseness penalty, with a selectable positive parameter.

The conventional NMF as described above may not be suitable for some applications, such as when applied to audio or video signals. Some audio components may be repetitive in time and/or frequency. Using the standard NMF would mean that the size of W and H should be increased to take into account all the repetitions. An increase in the size of the matrices W and H would mean an increase in the bitrate when audio coding applications are considered. An article by P. Samaragadis, Convolutive Speech Bases and their Application to Speech Separation, IEEE Trans. on Speech and Audio Processing U.S., and U.S. Pat. No. 7,415,392 issued to Smaragdis, both of which are incorporated herein by reference, disclose the use of a convolutive NMF, also referred to as non-negative matrix factor deconvolution (NMFD), for separation of a mixture of sounds received from a single-channel audio signal by associating different columns of the component matrix with different sound sources. In this approach, the input matrix V is formed of a sequence of spectrograms of short single frames, and the learning of the NMFD is performed off-line, using a large database of sound files. This approach may not be suitable for the purpose of audio encoding, when the encoding must be performed in real time.

Therefore, embodiments of the present invention utilize a version of the non-negative matrix factor 2-D (two-dimensional) deconvolution (NMF2D), which has been disclosed in M. Morup and M. Schmidt, Sparse Non-Negative Matrix Factor 2-D Deconvolution, Technical University of Denmark, 2008, which is incorporated herein by reference. We discovered that the NMF2D approach provides superior performance for audio encoding than the NMFD approach, in particular in terms of the achievable bit rate reduction for a same perceptual quality of the decoded audio at the decoder.

In the 2-D convolution version of the NMF, i.e. the NMF2D, the decomposition of the initial matrix V is done in the following form:

$$V \approx Λ ≡ {\sum }_{τ}^{ } {\sum }_{φ}^{ } {{W}^{τ}}^{↓ φ} {{H}^{φ}}^{\to τ} \qquad ( 3 )$$

where ↓φ denotes the downward shift operator which moves each element in the matrix φ rows down while adding φ all-zero rows at the top, and →τ denotes the right shift operator which moves each element in the matrix τ columns to the right, while adding τ all-zero columns at the left of the matrix. Here, instead of a single base matrix H and a single weight matrix W, we have a set of L base matrices H^{φ} and a set of D weight matrix W^{τ}, where L is the total number of shifts φ for the weight matrices W^{τ}, and D is the total number of shifts τ for the components matrices H^{φ}. The base matrices H^{φ} are also referred to herein as component matrices, as their columns contain ‘hidden’ components of the original ‘signal’ V that are being extracted by the NMF2D process. Accordingly, the process of obtaining the component matrices H^{φ} may also be referred to as the component, or object, extraction. In the following indices ‘τ’ and ‘φ’ may be omitted where it doesn't lead to a confusion, and the sets of matrices W^{τ} and H^{φ} may be referred to as the set of weight matrices W and the set of component matrices H, respectively. It will be appreciated that the set of D weight matrices W^{τ} can be viewed as a 3D (three-dimensional) weight matrix, and the set of L base matrices H^{φ} can be viewed as a 3D component matrix; accordingly, theses sets of matrices that are generated by the NMF2D may also be referred to herein as the 3D weight and component matrices.

The combined ‘weight’ ∥H∥ of the matrices H^{φ}, which enters into the sparseness penalty term of the cost function E, may be defined as follows using the norm L½:

$${‖ H ‖}_{1 / 2} = {( {\sum }_{φ , d , j}^{ } {( \vert {H}_{d , j}^{φ} \vert )}^{1 / 2} )}^{2} \qquad ( 4 )$$

Based on gradient descent, the following recursive updates may be used to compute the sets of matrices W^{τ} and H^{φ}:

$$\begin{matrix}{W}^{T} ← {W}^{T} \cdot \frac{{\sum }_{φ}^{ } {{VH}^{φ}}^{↑ φ ← τ} + {\tilde{W}}^{τ} diago ( {\sum }_{τ}^{ } 1 ( {( {Λ}^{′} {H}^{φ} )}^{↑ φ \to {τ}^{T}} \cdot {\tilde{W}}^{τ} ) )}{{\sum }_{φ}^{ } {{VH}^{φ}}^{↑ φ ← τ} + {\tilde{W}}^{τ} diago ( {\sum }_{τ}^{ } 1 ( {( V {H}^{φ} )}^{↑ φ \to {τ}^{T}} \cdot {\tilde{W}}^{τ} ) )} \\ and & ( 5 ) \\ {H}^{φ} ← {H}^{φ} \cdot \frac{{\sum }_{T}^{ } {{W}^{T}}^{↓ {φ}^{T}}}{{\sum }_{T}^{ } {{W}^{T} \tilde{Λ}}^{↓ {φ}^{T ← T}} + β \frac{{H}^{φ} \cdot ( - 1 / 2 )}{{‖ H ‖}_{1 / 2}^{- 1 / 2}}} & ( 6 )\end{matrix}$$

where \tilde{W}^{r} is a matrix which elements are defined by the following equation:

$${\tilde{W}}_{t , d}^{τ} = \frac{{W}_{t , d}^{τ}}{{‖ {W}_{d} ‖}_{2}} \\ {‖ {W}_{d} ‖}_{2} = {( {\sum }_{τ , t}^{ } {( \vert {W}_{t , d}^{τ} \vert )}^{2} )}^{1 / 2} \qquad ( 7 )$$

and \tilde{Λ} is calculated as follows after each update of H^{φ} and W^{τ}:

$$Λ = {\sum }_{τ}^{ } {\sum }_{φ}^{ } {{W}^{τ}}^{↓ φ} {{H}^{φ}}^{\to τ} \qquad ( 8 )$$

Update formulae for other types of sparsity penalties can be found in the aforecited article by M. Morup and M. Schmidt. Note that the set of matrices H^{φ} may be viewed as a 3D matrix, or more particularly a 3-D tensor. In embodiments when the NMF2D is applied to a spikegram, this tensor contains the chosen number K of hidden components, which are also referred to herein as objects, on one dimension, the length of the signal Non the second dimension, and the number of shifts L on the third dimension. Similarly, W is a 3-D tensor with the number of channels Mon the spikegram as the first dimension, the number K of hidden components as the second dimension, and the number of shifts D as the third dimension.

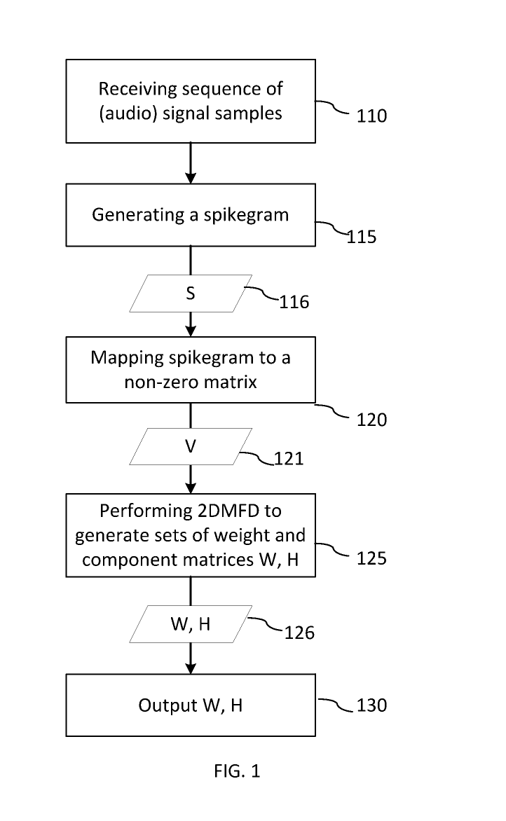

Referring now to FIG. 1, one embodiment of the present invention provides a method for processing an audio signal x(t) that includes the following general steps:

i) receiving a sequence of signal samples representing a selected duration of the audio signal x(t) at step 110;

ii) from the received sequence of signal samples, obtaining at step 115 a two-dimensional sparse matrix S 116 sparsely representing the selected duration of the audio signal in time and frequency domains in terms of an overcomplete signal library; if the matrix S116 includes negative elements, in step 120 it is mapped to a non-negative matrix V 121;

iii) generating in step 125 a set of weight matrices W and a set of component matrices H by performing the NMF2D of the sparse matrix S 116, or of a non-negative matrix V121 obtained therefrom, under a sparsity constrain; and,

iv) in step 130, outputting the sets 126 of weight and component matrices W, H for further processing or for storing in a computer readable memory; in accordance with the stated hereinabove, the sets 126 of weight and component matrices W, H are also referred to herein as 3Dweight (W) and component (H) matrices.

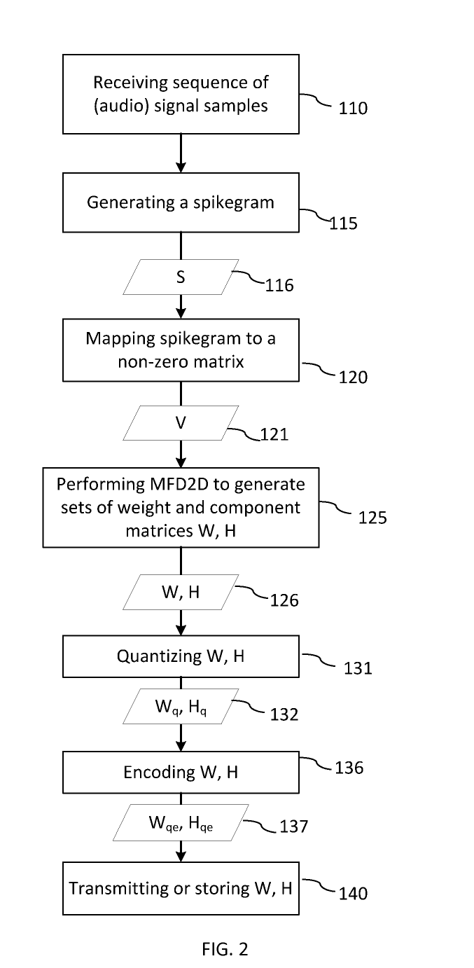

Referring now to FIG. 2, in one embodiment of the method step 125 is followed by additional steps 131, 136 and 140, wherein in step 131 all elements of the sets of matrices W, H126 are quantized, then in step 136 the resulting quantized matrices W_{q}, H_{q} 132 are encoded, for example using an entropy coding algorithm such as the arithmetic encoding which is known in the art, and then in step 140 the encoded quantized matrices W_{qe}, H_{qe} 137 stored in non-transient computer-readable memory and/or transmitted to a user for subsequent decoding and converting to sound.

In one embodiment, the 2-D sparse matrix S 116 is a spikegram that is computed by representing the input audio signal in terms of an over-complete library G of kernels gₘ(t), which is composed of nₘ time-shifted copies of M base dictionary elements gₘ(t), each gₘ(t) corresponding to a different center frequency fₘ, m=1, . . . , M, where M denotes the number of frequency channels in the representation. In the case of audio signals, these base dictionary elements gₘ(t) may be, for example, gammatone filter functions or gammachirp functions. The impulse responses of the gammatone filters approach that of actual responses observed in the human hearing system, and are given, for example, in our earlier U.S. Patent Application 2008/0219466 that is assigned to the assignee of the present application, and in an article H. Najaf-Zadeh, R. Pichevar, H. Landili, and L. Thibault, “Perceptual matching pursuit for audio coding,” in Audio Engineering Society Convention 124, 5 2008, both of which are incorporated herein by reference for all purposes.

In mathematical notations, a signal x(t) can be decomposed into the overcomplete kernels as follows:

$$x ( t ) = {\sum }_{m = 1}^{M} {\sum }_{i = 1}^{{n}_{m}} {a}_{i}^{m} {g}_{m} ( t - {τ}_{i}^{m} ) + {R}_{x} ( t ) , \qquad ( 9 )$$

where τᵢ^{m} and aᵢ^{m} are the temporal position and amplitude of the i^{th} instance of the kernel gₘ, respectively. The kernels are not generally restricted in form or length.

The dictionary elements gₘ(t) can be realized both in analog and digital domain, for example as digital or analog filters or correlators, or in software. Considering digital implementations by way of example, the input signal x(t) is digitized and is in the form of a sequence of frames of length N each, with N being the number of signal samples in one frame. In one embodiment, the input signal x(t) is a sampled audio signal; in other embodiments it can be a sampled video or image signal. Each dictionary element gₘ(t) may be viewed as an impulse responses of a finite impulse response (FIR) filter and mathematically represented as a vector of length N. In the overcomplete dictionary G, each base element gₘ has a length N_{gm}<N and is present in nₘ time-shifted copies that are spread over the frame length N, preferably uniformly. In one embodiment, each consecutive copy of a base element gₖ is shifted by q samples from the previous copy, thereby sampling each frame of the input signal x(t) with a sampling period q=N/nₘ, which may be referred to as the hop size.

Different techniques could be used to find an optimal subset of kernels gₘ, and the corresponding τᵢ^{m} and aᵢ^{m}. In one embodiment, MP can be used in step 115 to generate the spikegram 116, wherein the signal x(t) is decomposed over a set of kernels so as to capture the structure of the signal. The MP approach, which is well known in the art and will not be described here in detail, involves iteratively approximating the input signal x(t) with successive orthogonal projections onto the basis set of kernels, which may be described mathematically using the following equation (10):

x(t)=<x(t), gₘ(tᵢ)>·gₘ+Rₓ(t) (10)

where <x(t), gₘ(tᵢ)> is the inner product between the signal and the kernel and is equivalent to aᵢ^{m} in equation (9), which in the context of this specification is referred to as “spike amplitude”. Rₓ(t) is the residual signal representing an error of the approximation. In one embodiment wherein the input signal x(t) is an audio signal, the over-complete dictionary of kernels gₘ(t) may be gammatones or gammachirps. The process of generating a spikegram from a selected duration of an input audio signal using the MP technique is described, for example in U.S. Patent application No 2008/0219466, which is incorporated herein by reference.

In one embodiment, the spikegram 116 may be generated using an adaptive neural network, as described in U.S. Patent application No 2012/0023051, which is incorporated herein by reference.

In both techniques, the spikegram is generated by minimizing a cost function including an error function and a sparseness term. In some embodiments, the error function may be perceptually shaped according to an auditory masking pattern as described in Ref [1] and U.S. Patent application No 2012/0023051.

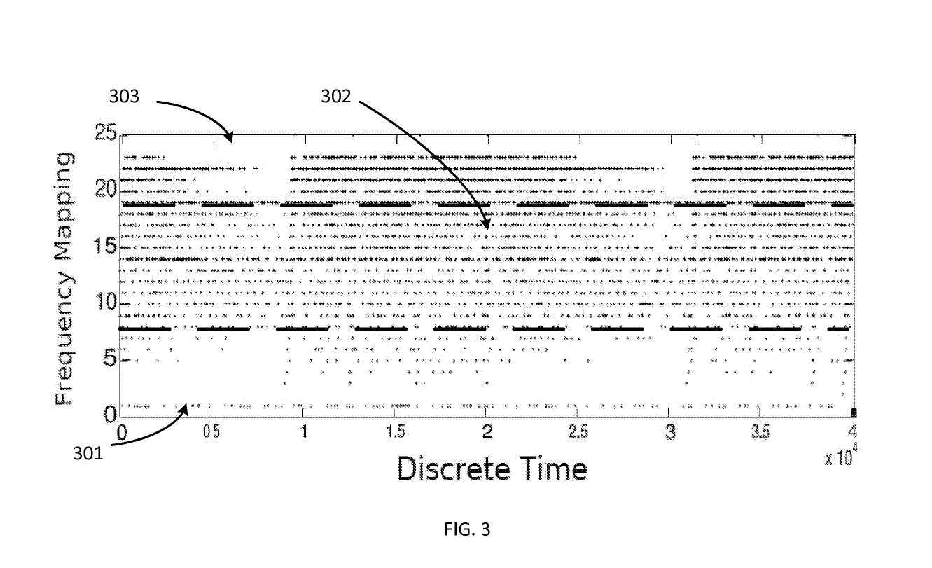

Using notations introduced hereinabove, in one embodiment the spikegram S 116 is an M×N matrix, with M being the number of channels and N being the length of the signal, i.e. the number of consecutive signal samples in the selected duration of the input audio signal, hereinafter referred to as ‘frame’. The matrix S has nonzero elements, or ‘spikes’, aᵢ^{m} at cells (m,τᵢ^{m}) of the matrix, with all the other elements being zero. In one embodiment, only channels that have more than a pre-determined minimal number of spikes per unit time, for example more than 10 spikes/second, are kept to increase ‘sparseness’ of the spikegram matrix. FIG. 3 illustrates an exemplary spikegram computed for an audio frame of 1 sec duration containing N=4×10⁴ samples, using a set of 25 Gammatone kernels, corresponding to a 25-channel representation of the audio frame. Each black point in the graph represents a location (m, τᵢ^{m}) of a ‘spike’; spike aᵢ^{m} amplitude not shown.

Note that the spikegram matrix S can have either positive or negative elements aᵢ^{m}, since the projections <x(t), gₘ(tᵢ)> may be either positive or negative. Accordingly, in one embodiment the spikegram S 116 is mapped to a non-negative matrix V 121. A variety of mapping procedures may be envisioned within the context of the present invention, resulting in a non-negative matrix V that is referred to herein as a modified spikegram 121. By way of example, this mapping may be performed in accordance with the following equations (11), yielding the non-negative matrix V of size 2M×N:

$$\{ \begin{matrix}V ( m , n ) = S ( m , n ) , & S ( m , n ) \geq 0 \\ V ( m , n ) = - S ( m , n ) , & S ( m , n ) < 0\end{matrix} \qquad ( 11 )$$

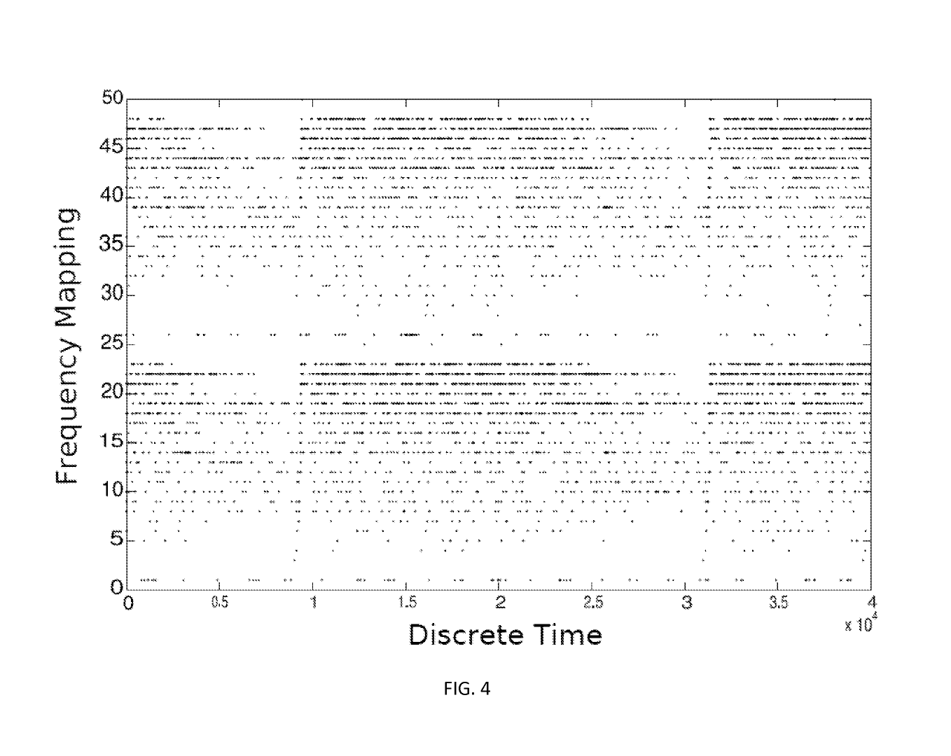

By way of example, FIG. 4 illustrates the modified spikegram matrix V that have been generated by extending the 25-channel representation of FIG. 3 to a 50-channel representation using equations (10). Many other mappings are possible, including interleaving of same-channel rows containing positive and negative spikes with ‘flipped’ sign.

Step 125 then involves applying the NMF2D technique, which is described herein above with reference to equations (3)-(8), to the modified spikegram matrix V 121 to obtain the sets 126 of the component, or base, matrices H and the weight matrices W. In one embodiment, this techniques involves iteratively updating the sets 126 of weights and component matrices to reduce a sparsity-dependent cost function below a threshold level. The technique may further include tuning one or more parameters of the technique so that a good reconstruction of the audio signal is achieved. The parameters that can be tuned in step 125 include one or more of the following: the number of hidden signal components K to look for, which defines the number of columns of the component matrices, the range of summation for φ which defines the number L of the component matrices H^{φ}, the range of summation for τ which defines the number D of the weight matrices W^{τ}, as well as the sparseness parameter λ.

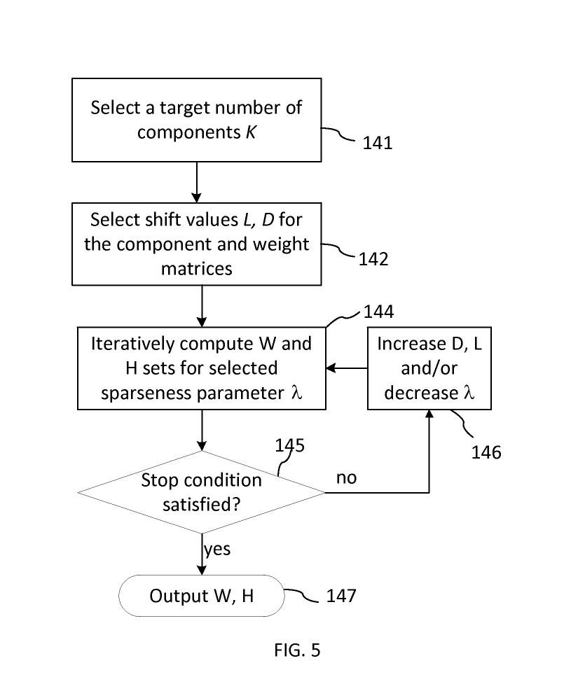

With reference to FIG. 5, in one embodiment of the invention the NMF2D processing of the modified spikegram 121 may include the following steps for fine-tuning the NMF2D parameters. First, in step 141a target number of components K is selected, thereby defining the size of the component matrices H. This step may be omitted if the value of K is determined off-line, for example during device calibration. At step 142, the sets of matrices H^{φ} and W^{τ}, φ=0: L, τ=0: D are initialized for selected initial values of the maximum shifts L and D. At steps 144-146, the iterative update algorithm, for example as defined by equations (5)-(8), is executed to determine optimum sets of matrices H^{φ} and W^{τ} for a pre-selected sparseness parameter λ. This algorithm includes computing updated matrices H^{φ} and W^{τ} at step 144 using equations (4), (5), and at step 145 verifying if a predetermined stop condition is satisfied. This step may include computing a cost function E, for example as defined by equation (2) or other suitable cost function equation, and comparing it to a selected threshold value Z, which is referred to hereinbelow as the (NMF) cost threshold. If the cost function is below the cost threshold, the iterations are stopped, the NMF2D processing terminates and the current sets of the matrices H^{φ} and W^{τ} are provided as the output sets of component and weight matrices 126. If the cost function exceeds the threshold, at step 146 the number of one or both of the shifts L and/or D is increased, for example by 1, i.e., L=(L+1) and D=(D+1), and/or the sparseness parameter λ is decreased by a selected factor, for example by 2, β=β/2, and the operation proceeds to step 144. In one embodiment, the iterations are stopped when the number of iterations exceeds a selected maximum number of iterations I.

Advantageously, we found that for audio signal encoding the optimal ranges in which the NMF2D parameters vary are typically small. By way of example, the range for L and D may be from 5 to 7; the initial value of λ may be selected to be 5.10⁻⁴, and may typically decrease down to 5.10⁻⁵.

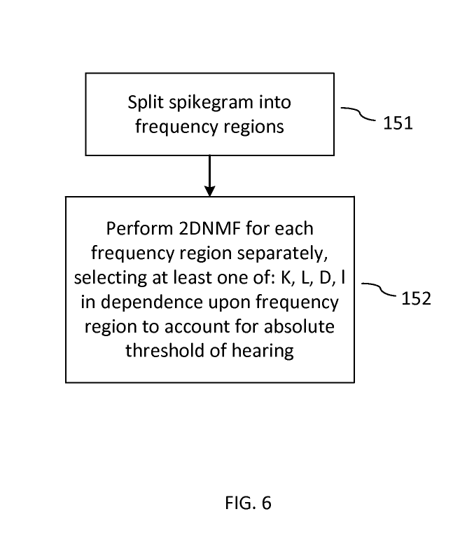

With reference to FIG. 6, in one embodiment, the 2D sparse representation 116 or 121 of the input signal is split at step 151 into a plurality of Θ segments in the time-frequency plane along the frequency axis, and at step 152 the aforedescribed NMF2D processing is performed separately on each segment. This enables to set differing tolerances to the error of the NMF2D deconvolution, according to a pre-determined frequency sensitivity at the user's end. In one embodiment, the NMF cost threshold Z is set differently for each segment according to the corresponding absolute threshold of hearing curve, which is known in the art. Furthermore, the size of φ, τ and of the sparsity factor λ may be set according to the amount of error tolerated for the specific frequencies. By way of example, for very low frequencies and for very high frequency when more error may be tolerated according to the absolute threshold of hearing, the size of φ and τ are reduced and the value of λ is increased to allow more sparsity. FIG. 3 illustrates an exemplary case wherein the spikegram 116 is split into three segments 301, 302 and 303, or three frequency regions, i.e. Θ=3, to differentiate between low frequencies, which are less perceptible to a human ear (segment 301), mid-frequencies that are highly perceptible to a human ear (segment 302), and high frequencies that are again less perceptible to a human ear (segment 303). For each of these segments, a separate modified non-negative spikegram matrix V_{θ} is formed, 0=1, . . . , Θ, and is then NMF2D processed as described hereinabove with reference to FIGS. 2 and/or 3. The frequency segmentation approach can be used with any other value of Θ depending on requirements of a particular application hardware computational capabilities.

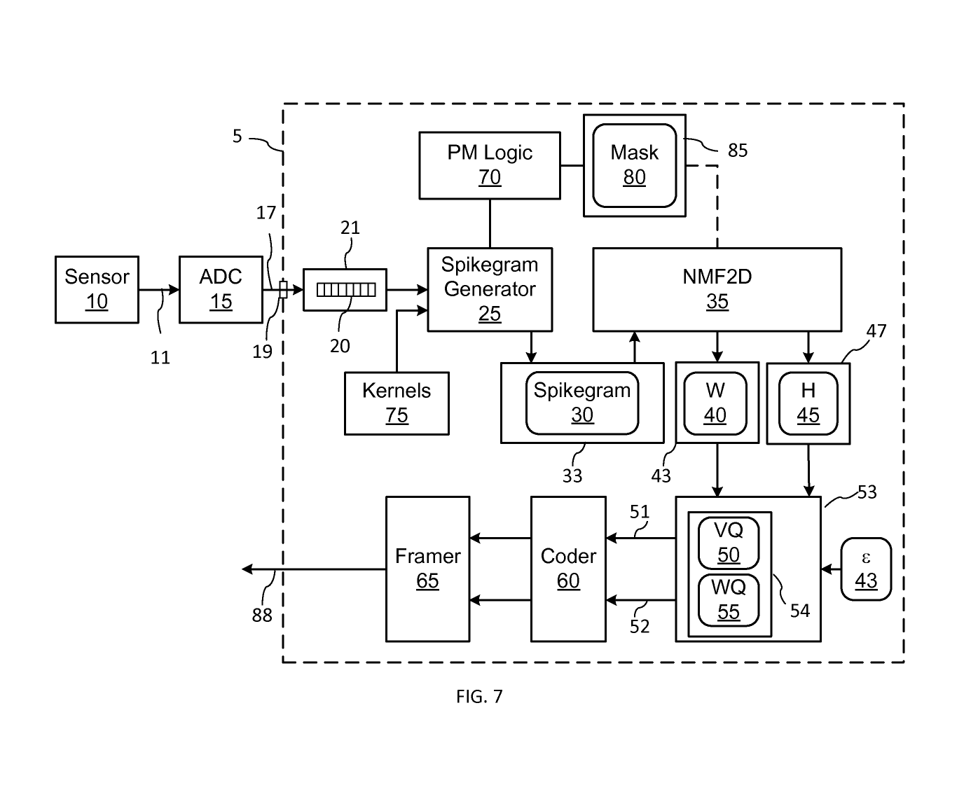

Referring now to FIG. 7, there is illustrated a schematic block diagram of an audio signal processing apparatus in accordance with an embodiment of the present invention. The apparatus includes a digital audio processor (DAP) 5 that includes memory and is configured for implementing one or more embodiments of the method of audio signal encoding described hereinabove, and may further optionally include a sensor 10, such as a microphone, and an analog-to-digital converter (ADC) 15. The DAP 5 includes an input port 19, a spikegram generation logic (SGL) 25, which is also referred to herein as the spikegram generator 25, an NMF2D engine 35, a quantizer logic 53, an entropy coder 60, and an output combiner or framer 65. The DAP 5 further includes various memory units 21, 33, 43, etc. as described hereinbelow. In operation, an audio signal 11 from the sensor 10 is first digitized by the ADC 15, and the resulting digitized audio signal 17 in the form of a stream of electrical signal samples is provided into an input buffer 21 of the DAP 5 via input port 19. The input buffer 21 accumulates a sequence of N signal samples 20 representing a selected duration of the input audio signal 11, and provides it to the SGL 25. The SGL 25 generates therefrom a spikegram 30 using the overcomplete set G of kernels gₘ, for example as described hereinabove with reference to FIGS. 1-5, and stores it in a spikegram memory unit 33. In one embodiment, the kernels gₘ that are used in the generation of the spikegram 30 are pre-stored in a kernel memory 75. In one embodiment, the SGL 25 allocates memory registers in the spikegram memory unit 33 for storing locations, i.e. indices, and amplitudes of non-zero elements aᵢ^{m} of the spikegram 30. In one embodiment, the spikegram 30 is stored in memory 33 in the form of the modified non-negative 2M×N spikegram matrix V 121 as described hereinabove. The NMF2D engine 35 reads the spikegram 30 from the memory 33, and executes the NMF2D algorithm to iteratively compute therefrom the set of the component matrices H 45 and the set of the weight matrices W, which are then stored in respective memory units 47 and 43. In one embodiment, the NMF2D engine35 is configured to implement the adaptive NMF2D logic described hereinabove with reference to FIG. 5, and may further be configured to dynamically allocate, within the memory units 43, 47, memory registers for storing K×N×L elements of the 3D component tensor H and 2M×K×D elements of the 3D weight tensor W, and may change the size of the allocated memory when executing step 146 of the process illustrated in FIG. 5. In one embodiment, the NMF2D engine 35 is configured to process the spikegram 30 in Θ separate frequency segments as described hereinabove, with the resulting sets of weight and component matrices for individual frequency segments being reassembled at the output, either before or after the quantization at the quantizer 53.

In one embodiment, the DAP 5 is further configured for implementing the NMF2D processing with a perceptual weighting of the deconvolution error that is comprised in the cost function E that the NMF2D engine 35 minimizes. In the conventional NMF2D algorithm that is described hereinabove with reference to equations (1) to (8), the cost function E includes the least square NMF error ∥V−WH∥, see for example equation (2). However, in the case of audio signals, the least square error is not very relevant perceptually. Therefore in at least one embodiment the least square error term in the NMF2D cost function E is perceptually weighted with a perceptual 2D mask PM={m_{b,k}}, which may be generated for example as disclosed in Ref. [1]. In one embodiment, the perceptually weighted cost function that is minimized by the NMF2D engine 35 takes the form given by the following equation (12):

$$E = {\sum }_{b , k}^{ } {{m}_{b , k} ( {v}_{b , k} - {[ {\sum }_{τ}^{ } {\sum }_{φ}^{ } {{W}^{τ}}^{↓ φ} {{H}^{φ}}^{\to τ} ]}_{b , k} )}^{2} + λ ‖ H ‖ \qquad ( 12 )$$

where m_{b,k} are elements of the perceptual mask matrix PM, ν_{b,k} are elements of the modified spikegram V 121, or of a frequency segment V_{θ} thereof. By defining PM as the masking matrix with elements m_{b,k} and replacing in equations (5), (6) ‘V’ with ‘PM·V’ and ‘H^{φ}W^{τ}’ with ‘PM·H^{φ}W^{τ}’, where symbol ‘·’ denotes element by element multiplication, we obtain the perceptually flavored update formulae for the component and weight matrices H^{φ} and W^{τ}. The advantage of the perceptually weighted update formulae is that the errors are concentrated below the mask instead of being spread evenly throughout the spectrum.

Accordingly, in one embodiment the DAP 5 includes perceptual masking logic (PML) 70. The PML 70 is coupled to the SGL 25, and in operation dynamically generates the perceptual mask PM 80 in dependence upon the spikegram 30. Note that the perceptual mask 80 accounts for dynamic masking of weak components of the audio signal by adjacent stronger components thereof, and thus generally varies from one audio frame 20 to another. Once generated PM 80 is saved in a perceptual mask memory 80, from which it is provided to the NMF2D engine 35 for implementing the perceptually weighted NMF2D algorithm as described hereinabove. Details of computing the perceptual mask 80 in embodiments wherein the SGL 25 implements the MP technique can be found in Ref. [1] which is incorporated herein by reference. In embodiments wherein the SGL 25 implements the neural network technique can be found in U.S. Patent Application 2012/0023051, which is incorporated herein by reference.

Continuing to refer to FIG. 7, the DAP 5 further includes the quantizer logic 53 for quantizing the matrices W and H generated by the NMF2D engine 35, which is followed by the entropy encoder 60. In one embodiment, the quantizer logic 53 implements vector quantization to quantize values in H^{φ}, and uniform quantization to quantize values in W^{τ}. This accounts for a typically much smaller size of the tensor W^{τ} as compared to H^{φ}, typically by 2-3 order of magnitude, due to which the bit cost of sending W^{τ} is typically much small than the bit cost of sending H^{φ}. Consequently a finer scalar quantization can be used for W^{τ} without penalizing the overall bitrate. By doing so, the learning time for vector quantization for matrix set W^{τ} may be saved. Conventional techniques for performing vector quantization and uniform quantization can be used; they are well known in the art and are not described here in further detail.

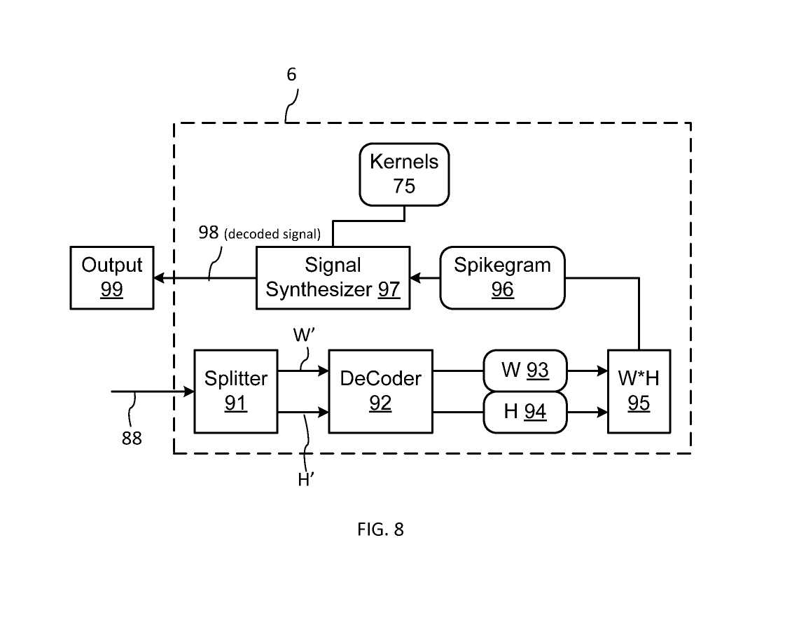

The quantized matrices Vq 50 and Wq 55 are then forwarded to the coder 60, which performs an entropy or arithmetic encoding of the quantized matrix values as known in the art; the resulting encoded data are then assembled in one or more frames by the output framer 65 and output as the encoded data 88. By way of example, in one embodiment the framer 65 concatenates the rows, columns and depth of the quantized and encoded 3D matrices W, H in a pre-defined order that is known to a complementary audio decoding device6 shown in FIG. 8 to produce the encoded data 88 in the form of a bit sequence.

With reference to FIG. 8, the encoded data 88 may be decoded by an audio decoder 6, which functions substantially in reverse to the DAP 5. The encoded data 88 are first split into 3D matrices W′ and H′ by a splitter 91, then elements of the matrices W′ and H′ are decoded by the decoder 92 which operates in reverse to the encoder 60 producing decoded matrices W and H, which are then used by an NMF2D reconstructor 95 to obtain a reconstructed spikegram 96 which is saved in a spikegram buffer that is not shown. A signal synthesizer 97 synthesizes a reconstructed audio signal 98 from the reconstructed spikegram 96 using the set of kernels gₘ 75. The reconstructed audio signal 98 is then passed to an output device 99, such as an audio player or a memory device for use at a later time.

Turning now back to FIG. 7, the process of quantization of 3D matrices W and H introduces a quantization error that adds to the NMF2D error described hereinabove. In order to maintain a desired perceptual quality of the reconstructed signal 98, this error has to be sufficiently small. Furthermore, it may be desirable to perceptually shape the quantization error in dependence upon the frequency and time of a given part of the signal, similarly as described hereinabove with respect to the NMF error. This may be accomplished by providing a suitable error matrix ε which has the same 2M×N size as the spikegram 30, wherein each element ε_{i,j} represents a maximum acceptable quantization error for the respective element v_{i,j} of the spikegram matrix V30.

One drawback of conventional quantization of the W and H matrices, either vector or scalar, is that it makes it difficult or even impossible to control the amount of quantization error in the reconstructed spikegram 96, and ultimately in the reconstructed audio signal 98. Indeed, in embodiments employing a standard quantization scheme, e.g., scalar or vector quantization, the quantization precision for each element hᵢⱼ of the component matrix H is set independently on the weights wᵢₖ, which are elements of the weight matrix W. Considering the standard NMF rather than the NMF2D for illustration purposes and by way of example, each element ν_{i,j} of the reconstructed spikegram is computed in accordance with the following equation (13):

$${v}_{ij} = {w}_{i 1} {h}_{1 j} + {w}_{i 2} {h}_{2 j} + … + {w}_{iN} {h}_{Nj} = {\sum }_{k = 1}^{k = N} {w}_{ik} {h}_{kj} \qquad ( 13 )$$

We note at this point that only one row of W, which we will denote Wⁱ, and one column of H, which we will denote H^{j}, are involved in defining a specific νᵢⱼ. Therefore, other rows of W and columns of H are not relevant to defining νᵢⱼ, which enables reducing the search in an optimization procedure described hereinbelow by only limiting the search space to one column or one row.

Furthermore, we make the following observations.

1) The sensitivity of the reconstructed signal 98 to the quantization error in any particular hₖⱼ depends on the weight wᵢₖ associated with it. A small wᵢₖ will lead to a relatively smaller contribution from the product wᵢₖhₖⱼ to the overall sum in the RHS of equation (13) and vice versa. For instance, in the extreme case when the weight wᵢ₁=0, any error can be tolerated on hᵢ₁ since the result of the multiplication of wᵢ₁h₁ⱼ is always zero. Therefore, one can set in that case hₖⱼ=0, no matter the real value of hₖⱼ, and use the minimum number of bits to address that element. Accordingly, the NMF quantization scheme that is provided in accordance with an embodiment of the present invention employs an adaptive quantization approach wherein the quantization level of a particular element hₖⱼ of a component matrix H is determined in dependence upon the magnitude of the associated weight.

2) For a given bound εᵢⱼ on the error of the spike amplitude vᵢⱼ and a given set wᵢₖ in Wⁱ, there might be different combinations of hₖⱼ in H^{j} that will satisfy the quantization error bounds [vᵢⱼ−εᵢⱼ; vᵢⱼ+εᵢⱼ] on the magnitude of vᵢⱼ. However, not all of the solutions will result in a minimum bitrate for transmitting the output data 88. When an entropy coding is used, the bitrate depends on the number of non-zero elements hₖⱼ in the quantized matrix Hq and their distribution in magnitude P(hₖⱼ), which defines what fraction of all matrix elements hₖⱼ has a magnitude within a particular range. One solution to this problem would be to choose a combination of hₖⱼ that will lead to the sparest solution, i.e. has the greatest possible number of hₖⱼ=0.

3) There is no one-to-one correspondence between the tolerated error ε in vᵢⱼ and the actual error in each element hₖⱼ when the standard quantization is used. Without a trial and error based approach, it is not possible to know a priori how many quantization levels q should be used in the scalar quantizer so that the error in the reconstructed spikes does not cross the target maximum allowable quantization error ε.

Accordingly, an embodiment of the present invention utilizes a weight-adaptive quantization approach wherein the number of quantization levels for each non-zero spike magnitude hₖⱼ is chosen adaptively based on the magnitude of the corresponding weight wᵢₖ and the maximum allowable quantization error ε_{i,j}. The approach is different from non-adaptive scalar and vector quantization where the number of quantization levels is fixed for all values to be quantized. The technique differs from prior-art adaptive quantizers, wherein the number of levels of quantization varies in time/space as a function of the signal statistics in a given frame. Contrary to that, in the adaptive quantization that is used in embodiments of the present invention, the number of levels of quantization for each hₖⱼ varies in dependence on the magnitude of the respective weight coefficient wᵢₖ.

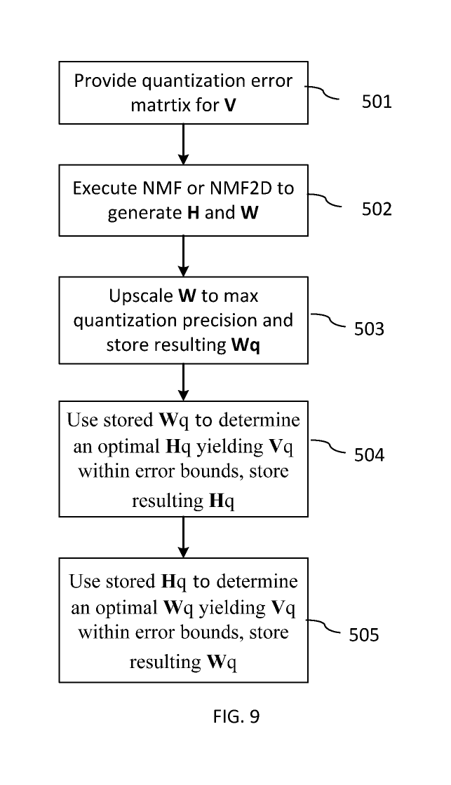

With reference to FIG. 9, the weight-adaptive quantization process of the present invention in one embodiment thereof includes the following steps.

At step 501, provide an error matrix ε 43, elements of which define maximum allowable error for each element of the spikegram matrix V30; in one embodiment elements of the error matrix ε are quantized to a maximum desired precision corresponding to a pre-defined maximum number of quantization levels Q. The quantization error matrix ε 43 defines the upper and lower error bounds for the ‘quantized’ matrix Vq=Wq [symbol] Hq:

xₘₐₓ=└V+ε┘

xₘᵢₙ=└V−ε┘ (14)

Equations (14) are written in a matrix form and hold for each element of the respective matrices at the same positions. The notation ‘└X┘’ defines the largest integer equal or less than X.

At step 502, execute NMF or NMF2D to generate the weight and component matrices W, H.

At step 503, upscale the weight matrix W to the maximum desired precision, i.e. using Q levels of quantization, to obtain a quantized weight matrix Wq. Note that in this scheme the quantization is adaptive and the number of quantization levels for each element in H can range from 0 levels up to the maximum number of Q levels. After this up-scaling operation, a maximum value in W is equal to Q.

At step 504, execute an optimization procedure to determine an optimal Hq for the given fixed Wq that yield Vq which lies within the error bounds defined by equations (14), i.e.

xₘᵢₙ≦Vq≦xₘₐₓ, (15)

and save resulting Hq in memory;

At step 505, execute an optimization procedure to determine an optimal Wq for the Hq saved in the previous step that yields Vq within the error bounds (15), and save resulting Wq in memory; this step is optional given the small size of W, and can be omitted in some embodiments.

f) optionally repeat steps 504 and 505 if required.

A variety of suitable optimization procedures could be used in steps 504 and 505 within the scope of the present invention. In one embodiment, these steps are conveniently performed using integer programming.

The integer programming, as known in the art, is a method for a computer for solving a linear optimization problem that can be mathematically formulated as follows:

$$find all integer {x}_{j} that minimize {\sum }_{j = 1}^{n} {c}_{j} {x}_{j} \qquad ( 16 )$$

subject to the following conditions:

$${\sum }_{j = 1}^{n} {a}_{ij} {x}_{j} = {b}_{i} ( i = 1 , 2 , … m ) \\ {x}_{j} \geq 0 ( j = 1 , 2 , … , n ) \\ {x}_{j} integer for all j \qquad ( 17 )$$

Different algorithms for solving the problem of the type given by equations (16), (17) are known in the art and could be used in embodiments of the present invention. One suitable algorithm for integer programming is the branch-and-bound algorithm, which is disclosed, for example, in A. H. Land and A. G. Doig (1960). “An automatic method of solving discrete programming problems”. Econometrica 28 (3): pp. 497-520. The integer linear program is a linear program further constrained by the integrality restrictions. Thus, in a maximization/minimization problem, the value of the objective function, at the linear-program optimum, will always be an upper bound on the optimal integer-programming objective. In addition, any integer feasible point is always a lower bound on the optimal linear-program objective value. The idea of branch-and-bound is to utilize these observations to systematically subdivide the linear programming feasible region and make assessments of the integer-programming problem based upon these subdivisions.

In one embodiment, an integer programming algorithm is used in step 504 to determine an optimal quantization scheme for elements of the complement matrix by solving the following linear integer problem:

min|H_{q}^{j}| (18)

under the condition

xₘᵢₙ^{ij}<WⁱH_{q}^{j}<xₘₐₓ^{ij} (19)

where H_{q}^{j} denotes j^{th} column of the optimized matrix Hq, and Wⁱ as the i^{th} row of W, and xₘᵢₙ^{ij} and xₘₐₓ^{ij} as the (i, j)^{th} element of matrices xₘᵢₙ and xₘₐₓ, respectively, which elements define the upper and lower error bounds for the reconstructed spikegram matrix Vq 96.

Since only one row and one column of W and H contribute to the quantization error in any vᵢⱼ, the optimization may be performed for each row i of W and each column j of H separately in order to save in computational cost.

In this embodiment, the quantizer logic 53 is configured to find, using an integer programming algorithm, a minimum-weight vector H_{q}^{j} which non-zero elements are integer and satisfy condition (19), i.e. result, for a given weight matrix W, in elements of reconstructed spikegram that lie within the predetermined error bounds. In another embodiment, the ‘lowest-weight’ condition (19) is not used, and the integer programming algorithm is executed with the constrain (19) but without any object function to minimize.

In step (e), in one embodiment an integer programming algorithm is used to solve the following linear integer problem:

find min |W_{q}^{j}| (20)

under the condition

xₘᵢₙ^{ij}<W_{q}ⁱH_{q}^{j}<xₘₐₓ^{ij} (21)

where H_{q}^{j} denotes j^{th} column of the optimized matrix Hq saved in step 504, and W_{q}ⁱ denotes the i^{th} row of the matrix Wq. Again, in this step the optimization is done on one row and one column of W and H. In this embodiment, the quantizer logic 53 is configured to find, using an integer programming algorithm, a minimum-weight vector W_{q}ⁱ which non-zero elements are integer and satisfy condition (21), i.e. result, for a give weight matrix W, in elements of reconstructed spikegram that lie within the predetermined error bounds. In another embodiment, the ‘lowest-weight’ condition (20) is not used, and the integer programming algorithm is executed with the constrain (21) but without any object function to minimize

The minimum-weight conditions (18), (20) which are imposed on columns of the quantized component matrix and/or the rows of the quantized weight matrix, have that advantage that they increases the sparseness of the representation, thereby enabling lower bitrates. The technique is extended to NMF2D by replacing in equations (19), (21) with the RHS of equation (8).

In one embodiment, the quantizer logic 53 implements in step 504 a piecewise-linear quantization by integer programming (QIP) of the NMF2D matrix H as described hereinbelow. The QIP process enables to quantize elements of H with different precisions in different regions, which may be preferable when the distribution of values in H is not uniform. In this case, it is preferable to use higher precision for those ranges of values for which the concentration is high in the distribution and a coarser precision for those regions with sparser density.

The process may be explained as follows. We denote an element of the up-scaled to Q component matrix to be quantized as H temporarily omitting indices i, j for clarity, and further denote the quantization levels that are to be used for ranges of values with upper bounds a₁, a₂, a₃, . . . a_{N} as q₁, q₂, q₃, . . . , q_{N}, respectively, wherein N here is the desired number of distinct quantization regions and can range, for example, from 2 to (Q−1). These sets of quantization ranges aᵢ and their corresponding quantization levels qᵢ are pre-defined prior to the processing and stored in memory. By way of example, for audio signals smaller values that correspond to quieter sound could be quantized with finer precision than larger values that correspond to louder sound. The task of the following processing is to determine optimal distributions of the quantization levels in each of the pre-defined ranges of values [aᵢ aᵢ₊₁]. In that case, if a quantized value of H, i.e. H_{q}, falls in the region [aᵢaᵢ₊₁], it can be written as:

$${H}_{q} = {a}_{i} + \frac{{a}_{i + 1} - {a}_{i}}{{q}_{i}} {l}_{i} \qquad ( 22 )$$

Where l is an integer between aᵢ and aᵢ₊₁. We further introduce variables δᵢ, i=1, . . . , N, such that they satisfy the following conditions:

$$0 \leq {δ}_{1} \leq {a}_{1} \\ 0 \leq {δ}_{2} \leq {a}_{2} - {a}_{1} \\ ⋮⋮ \\ 0 \leq {δ}_{N} \leq {a}_{N} - {a}_{N - 1} \qquad ( 23 )$$

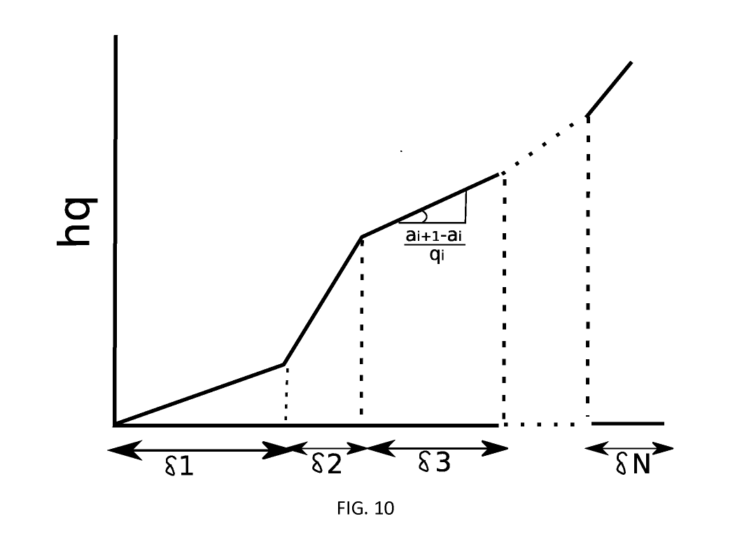

Note that the variable δ₁ corresponds to the amount by which H exceed 0, but is less than or equal to a₁; δ₂ corresponds to the amount by which H exceed a₁, but is less than or equal to a₂. δ_{N} corresponds to the amount by which H exceed a_{N-1}, but is less than or equal to a_{N}. Note that δᵢ in FIG. 10 are variables that are determined during the optimization. The arrows for each δᵢ in the Figure shows the range in which those variables can change.

Therefore Hq, which is the quantized value for H, may be computed by summing suitably scaled variables δᵢ:

$${H}_{q} = {\sum }_{i}^{ } \frac{{a}_{i + 1} - {a}_{i}}{{q}_{i}} {δ}_{i} . \qquad ( 24 )$$

Equation (24) is applied to every non-zero element of the 3D component matrix H. In order for the equation (24) to be valid, we should further require that δ₁=aₗ whenever δ₂>0, δ₂=a₂ whenever δ₃>0 and so on. These conditional constraints can be modeled by introducing binary variables

$${b}_{i} = \{ \begin{matrix}1 & if {δ}_{i} is at its upper bound \\ 0 & otherwise\end{matrix} \qquad ( 25 )$$

By integrating the binary variable bᵢ into the equations (23), we obtain:

$$\begin{matrix}{L}_{1} {b}_{1} \leq {δ}_{1} \leq {L}_{1} \\ {L}_{2} {b}_{2} \leq {δ}_{2} \leq {L}_{2} {b}_{1} \\ ⋮⋮ \\ 0 \leq {δ}_{N} \leq {L}_{N} {b}_{N} \\ where & ( 26 ) \\ {L}_{i} = {a}_{i + 1} - {a}_{i} & ( 27 )\end{matrix}$$

With these notations, the minimization problem to be solved may be formulated as follows: find all δᵢ that minimise the objective function given by an absolute value of their sum,

$$Min \{ {\sum }_{i}^{ } {δ}_{i} \} \qquad ( 28 )$$

under the following conditions:

xₘᵢₙ^{i,j}<WⁱH_{q}ⁱ<xₘₐₓ^{i,j} (29)

and

Lᵢ·bᵢ<δᵢ<Lᵢ·bᵢ₋₁ (30)

where each element of H_{q}ⁱ is computed in accordance with Equation (24); xₘᵢₙ^{i,j} and xₘₐₓ^{i,j} are defined in Equation (19).

This technique can be applied to audio coding, in particular to quantize elements of the component matrices H in step 504 of the process of FIG. 9. Accordingly in one embodiment of the process of FIG. 9 the component matrices H are quantized using the QIP algorithm described hereinabove with reference to equations (22) to (30) to find a set of optimal quantized matrices Hq, i.e. to find optimal quantized values for elements h_{k,j} of H. The elements hq_{k,j} of Hq may then be concatenated in a stream of integers [h₁₁, h₁₂, h₁₃, . . . , h_{1N}, h₂₁, h₂₂, . . . ] 51. Note that values in the stream can range from 0 to the maximum allowable integer Q, which by way of example may be 64, 128, 256, etc.

Accordingly, in one embodiment of the invention the data processing in step 504 includes the following steps for each element H of the 3D component matrix: i) providing the pre-defined sets of quantization ranges aᵢ and their corresponding quantization levels qᵢ thereby defining a piecewise linear function is in accordance with equation (22); ii) generate an initial set of N variables δᵢ in accordance with equations (23); iv) generate binary variables bᵢ in accordance with equation (25); v) use an integer programming algorithm to solve the optimization problem as stated in equations (28)-(30) to determine optimal δᵢ and optimal binary variables bᵢ. vi) compute the quantized component matrix value Hq using equation (24).

The integer streams 51 and 52 are then passed to the encoder 60, such as an arithmetic encoder known in the art for additional encoding to reduce size. The arithmetic encoding step is optional and may be omitted in some embodiments. The framer 65 then combines the encoded stream of quantized elements of the component matrices H with an encoded stream of quantized elements of the weight matrices, for example by concatenating, to form one frame of the output encoded audio signal 88. The encoded stream 88 may also contain side information when needed to decode the stream.

TABLE 1

| Maximum | Relative | |
|---|---|---|
| Number of | Minimal Difference | Relative Minimal Difference |
| Quantization Levels | from Upper Bound | from Lower Bound |
| 32 | Infeasible | Infeasible |
| 64 | −0.01 | 2 × 10⁻⁷ |
| 128 | −0.02 | 9 × 10⁻⁷ |
| 256 | −0.02 | 6 × 10⁻⁷ |
| 512 | −0.02 | 1.5 × 10⁻⁸ |
| 1024 | −0.02 | 8 × 10⁻⁸ |

By way of example, Table 1 shows the reconstruction error at the decoder 6 for different values of the maximum number Q of quantization levels for an exemplary audio signal when using the QIP technique. The table shows that the error is inside the lower bounds for Q=64, 128, 256, 512, and 1024 quantization levels. Note that when the maximum number of quantization levels Q is said to be 1024, it means that values hₖ are between 0 and 1024. In the case of 32 levels, the optimization was not achieved. Note that with a scalar quantization the error bounds were not respected even with 1024 quantization levels. The term ‘Relative Minimal Difference from Upper Bound’ as used in the table means the minimum of the difference between the upper bound and actual values, for all elements in the matrix H and/or W, divided by the value of the element itself. The term Relative Minimal Difference from Lower Bound’ as used in the table means the maximum of the difference between the lower bound and actual values, for all elements in the matrix H and/or W, divided by the value of the element itself.

Advantageously, we found that for a typical matrix H generated by the NMF2D engine, the required number of bits reduces by 65% on average when aforedescribed QIP technique is used compared to the standard scalar quantization with 1024 quantization levels. In order to perform a fair comparison between the two approaches, we generated two bitstreams: one for the output of the scalar quantizer and one for the output of the QIP quantizer. We then arithmetic coded both streams. If we didn't want to use arithmetic coding for the standard scalar quantizer, which is not a mandatory step, the bitrate would even be higher. In fact, in the case where a fixed number of bits, i.e., 10 bits by way of example, is used for the scalar quantizer, the gain of the QIP approach and is even higher and is around 70% on average. Furthermore, when the additional optimization cost function |H| is used in the QIP technique as disclosed hereinabove, and arithmetic coding is used in both cases, the gain in ‘bit-compactness’ is increased to 75% compared to the scalar quantization.

The audio encoding logic and operations described hereinabove may be implemented as a method, apparatus or article of manufacture using standard programming and/or engineering techniques to produce software, firmware, hardware, or any combination thereof.

In one embodiment, DAP 5 may be implemented using one or more digital processors, and may be incorporated into a portable device such as a cellular phone including a smartphone, or generally in any digital audio recording device. Each of the functional blocks 25, 35, 53, 60 and 65 of DAP 5 of FIG. 7 may be implemented either in software or hardware logic.

One implementation of the invention provides an article of manufacture that comprises at least one of a hardware device having hardware logic and a computer readable storage medium including a computer program code embodied therein that is executable by a computer, said computer program code comprising instructions for performing some of all of the operations described hereinabove for encoding digitized audio signal, said computer program code further comprising distinct software modules, the distinct software modules comprising a spikegram generating module, an NMF2D module, and a quantizer module. In one implementation, one or more of these modules are implemented with hardware logic using an ASIC and/or an FPGA.

The term “article of manufacture” as used herein refers to code or logic implemented in hardware logic, for example an integrated circuit chip, FPGA, ASIC, etc., or a computer readable medium, such as but not limited to magnetic storage medium, for example hard disk drives, floppy disks, tape, etc., optical storage, for example CD-ROMs, optical disks, etc., volatile and non-volatile memory devices, for example EEPROMs, ROMs, PROMs, RAMs, DRAMs, SRAMs, firmware, programmable logic, etc. Code in the computer readable medium is accessed and executed by a processor. Of course, those skilled in the art will recognize that many modifications may be made to this configuration without departing from the scope of the present invention, and that the article of manufacture may comprise any information bearing non-transient tangible medium known in the art.

Although embodiments of the invention have been described hereinabove with reference to audio signals, the aforedescribed sparse encoding with object extraction using NMF2D, and the adaptive quantization using the QIP technique are also applicable to other types of signals such as video signals and signals representing images, and the application of the aforedescribed techniques to such signals are also intended to be within the scope of the present invention. For example, in the case of video or image signals, the overcomplete set G of kernels, such as Gabor kernels for images, may be defined for spatial coordinates(x,y) in the image, resulting in a 2D spikegram representing spatial coordinates (x,y). It should also be understood that each of the preceding embodiments of the present invention may utilize a portion of another embodiment

Of course numerous other embodiments may be envisioned without departing from the spirit and scope of the invention.

We claim:

1. A method for encoding an audio signal by an audio encoding apparatus, the audio encoding apparatus comprising data processing hardware, the method comprising:
a) receiving a sequence of electrical signal samples representing a selected duration of the audio signal;
b) from the received sequence of electrical signal samples, obtaining a two-dimensional spikegram sparsely representing the selected duration of the audio signal in time and frequency domains in terms of an overcomplete signal library;
c) generating a set of weight matrices W and a set of component matrices H by performing a two-dimensional non-negative matrix factorization (NMF2D) of the spikegram, or of a non-negative matrix V obtained therefrom, under a sparsity constrain;
d) quantizing non-zero values of the weight matrices W and the component matrices H;
e) encoding W and H to obtain encoded audio data; and,
f) outputting the encoded audio data for transmission to a complimentary audio decoder or storing in a computer-readable medium.

2. The method of claim 1, wherein step (c) comprises iterative updating the sets of weights and component matrices to reduce a sparsity-dependent cost function below a threshold level.

3. The method of claim 2 wherein the cost function comprises a sparseness parameter β.

4. The method of claim 3, wherein step (c) is performed so as to account for a frequency dependence of an absolute threshold of hearing.

5. The method of claim 4, comprising obtaining different sets of weight and component matrices for different frequency regions.

6. The method of claim 5, wherein step (c) includes using different values of at least one parameter from the list of following parameters: a NMF2D error, a number D of matrices in the set of weights matrices W, a number L of matrices in the set of component matrices H, a number of columns of the component matrix, and the sparsity factor β, in dependence upon the frequency region.

7. The method of claim 2, wherein step (c) comprises using a perceptual weighting mask in the iterative updating to account for perceptual masking effects in hearing.

8. The method of claim 2, wherein the iterative updating in step (c) includes computing a NMF2D error, and updating at least one parameter selected from the list of following parameters: a number D of matrices in the set of weights matrices W, a number L of matrices in the set of component matrices H, a number of columns of the component matrix, and the sparsity factor β, if the computed NMF2D error exceeds a pre-set error limit.

9. The method of claim 1, wherein the number of columns in the component matrices H is selected in accordance with a desired number of extracted components in the audio signal.

10. The method of claim 1, wherein step d) comprises selecting a number of quantization levels for the non-zero values of the component matrices H in dependence upon values of corresponding elements of the weight matrices associated therewith.

11. The method of claim 10, wherein the number of quantization levels in step d) is selected using integer programming in dependence upon the non-zero value being quantized.

12. A method of claim 1, further comprising converting the spikegram into the non-negative matrix V prior to step c).

13. A method of claim 1, wherein the non-negative matrix V comprises at least twice as many rows or columns as the spikegram.

14. An audio signal processing apparatus, comprising:
a spikegram generation logic for receiving a sequence of electrical signal samples representing a selected duration of an audio signal, and for generating a spikegram based thereon, wherein the spikegram represents the selected duration of the input audio signal in time and frequency domains in terms of an overcomplete signal library;
a matrix factorization logic for generating a set of weight matrices W and a set of component matrices H by performing a two-dimensional non-negative matrix factorization (NMF2D) of the spikegram, or of a non-negative matrix V obtained therefrom, under a sparsity constrain;
a quantizer for quantizing non-zero values of the weight matrices W and the component matrices H; and,
an encoder for encoding the weight matrices W and the component matrices H to obtain encoded audio data for transmission to a complimentary audio decoder or storing in a computer-readable medium.

15. An audio signal processing apparatus of claim 14 comprising one or more memory devices, the one or more memory devices comprising:
a first memory unit allocated as an input buffer for storing the sequence of electrical signal samples representing the selected duration of the input audio signal;
a second memory unit allocated for storing the spikegram; and,
a third memory unit allocated for storing the sets of the weight matrices W and the component matrices H.

16. An audio signal processing apparatus of claim 14, wherein the matrix factorization logic is configured for iteratively updating the sets of weights and component matrices to reduce a sparsity-dependent cost function below a threshold level.

17. An audio signal processing apparatus of claim 15, further comprising:
a perceptual mask generator coupled to the second memory unit for generating a perceptual hearing mask based on the spikegram stored therein, and
a fourth memory unit for storing the perceptual hearing mask,
wherein the fourth memory unit is coupled to the matrix factorization logic for use in the generating of the sets of the weight matrices W and the component matrices H.

18. An audio signal processing apparatus of claim 14, wherein the matrix factorization logic is configured for splitting the spikegram into a plurality of spikegram segments, each segment representing a different frequency region, and for obtaining different sets of weight and component matrices for different frequency regions so as to account for a frequency dependence of an absolute threshold of hearing.

19. An article of manufacture comprising at least one of:
a hardware device having hardware logic for performing operations for encoding an audio signal, and
a computer readable storage medium including a computer program code embodied therein that is executable by a computer, said computer program code comprising instructions for performing the operations for encoding the audio signal, said computer program code further comprising distinct software modules, the distinct software modules comprising a spikegram generating module for generating a spikegram and a matrix factorization module for performing a two-dimensional non-negative matrix factorization (NMF2D) of the spikegram;
wherein said operations comprise:
a) receiving a sequence of electrical signal samples representing a selected duration of the audio signal;
b) from the received sequence of electrical signal samples, obtaining a two-dimensional spikegram sparsely representing the selected duration of the audio signal in time and frequency domains in terms of an overcomplete signal library;
c) generating a set of weight matrices W and a set of component matrices H by performing a two-dimensional matrix factor deconvolution (2DMFD) of the spikegram, or of a non-negative matrix V obtained therefrom, under a sparsity constrain;
d) quantizing non-zero values of the weight matrices W and the component matrices H;
e) encoding W and H to obtain encoded audio data; and,
f) outputting the encoded audio data for transmission to a complimentary audio decoder or storing in a computer-readable medium.
